(19) United States
(12) Patent Application Publication
(10) Pub. No.: US 2007/0189204 A1
(43) Pub. Date: Aug. 16, 2007

(54) Method for communication in a wlan with a group of relay stations and radio access points

(76) Inventors: Hui Li, Beijing (CN); Egon Schulz, Munchen (DE); Dan Yu, Beijing (CN)

Correspondence Address: STAAS & HALSEY LLP, SUITE 700, 1201 NEW YORK AVENUE, N.W., WASHINGTON, DC, 20005, US

(21) Appl. No.: 11/547,320

(22) PCT Filed: Mar. 4, 2005
(86) PCT No.: PCT/EP05/50970

§ 371 Date: Oct. 2, 2006

(30) Foreign Application Priority Data
Mar. 31, 2004 (DE) 10 2004 015 895.9

(51) Int. Cl. H04B 7/15; H04Q 7/00

(52) U.S. Cl. 370/328; 370/338

(57) ABSTRACT

A first radio station of a group of radio stations identifies at least one adjacent radio station of the group while using a first radio interface. The first radio station then transmits information concerning the at least one adjacent radio station, which is determined by the first radio station, to a second radio station in the group using a second radio interface. Afterwards, the second radio station transmits path information to the first radio station using the second radio interface. From the path information, it can be inferred with regard to every other radio station of the group, to which radio station respectively adjacent to the first radio station a message addressed to the respective other radio station of the group is to be sent by the first radio station using the first interface.

### CROSS REFERENCE TO RELATED APPLICATIONS

This application is based on and hereby claims priority to German Application No. 10 2004 025 895.9 filed on Mar. 31, 2004, the contents of which are hereby incorporated by reference.

### BACKGROUND

Described below is communication in a radio communications system, in which a radio station determines radio stations in its neighborhood and transmits information about neighboring radio stations determined to a further radio station..

In radio communications systems information (for example speech, picture information, video information, SMS (Short Message Service) MMS (Multimedia Messaging Service) or other data) is transmitted with the aid of electromagnetic waves via a radio interface between transmitting and receiving station. The radio stations can in this case, depending on the concrete embodiment of the radio communications system be various types of subscriber-side radio station such as computers or telephones for example, or network-side radio stations such as repeaters or relay stations, radio access points or base stations. In a mobile radio communications system at least one part of the subscriber-side radio stations are mobile radio stations. The electromagnetic waves are emitted with carrier frequencies which lie in the frequency band provided for the relevant system.

Mobile radio communications systems are often embodied as cellular systems, e.g. in accordance with the GSM (Global System for Mobile Communication) or UMTS (Universal Mobile Telecommunications system) standard, with a network infrastructure including, for example, base stations, devices for checking and control of the base stations and further network-side devices.

As well as these cellular, hierarchical radio networks organized on a wide-area (supralocal) basis, there are also Wireless Local Area Networks (WLANs) with a radio coverage area that as a rule is far more limited. The cells covered by the radio access points (AP) of the WLANs, with a radius of up to a few hundred meters as a rule, are small by comparison with usual mobile radio cells. Examples of different standards for WLANs are HiperLAN, DECT, IEEE 802.11, Bluetooth and WATM.

Generally the non-licensed frequency range around 2.4 GHz is used for WLANs. Data transmission rates range up to around 11 Mbit/s. Future WLANs can be operated in the 5 GHz range and will achieve data rates of over 50 Mbit/s. This provides subscribers of the WLANs with data rates which are significantly higher than those offered by the third mobile radio generation (such as UMTS for example). This means that for the transmission of large volumes of data, especially in connection with Internet accesses, access to WLANs for high-bit-rate connections is advantageous.

A connection to other communication systems, for example to the Internet, can thus be made via the WLAN radio access points. To this end the subscriber-side radio stations of the WLAN communicate either directly with a radio access point or with more remote radio stations via other network-side or subscriber-side radio stations which forward the information between the radio station and the radio access point over a path between the radio station and the radio access point. Before this type of forwarding can be undertaken such a path must be determined. There is a multiplicity of methods available for determining the path. A path can be determined if this is currently needed for message transmission (on demand), or also in advance regardless of demand.

### SUMMARY

An aspect is to demonstrate a method for communication by radio which allows an execution sequence of communication in a group of radio stations, which for communication can transmit messages from radio station to radio station over a path via neighboring radio stations in each case. Furthermore radio stations for executing the method are to be presented.

This method for communication in a radio communications system, which includes a group of radio stations and a further radio station, whereby the group includes a first radio station and a plurality of other radio stations, the following operations are executed: i. Firstly the first radio station of the group determines at least one radio station of the group in its neighborhood using a first radio interface.
ii. Then the first radio station transfers information about the at least one neighboring radio station determined by it to the further radio station using a second radio interface.
iii. Subsequently the further radio station transfers path information to the first radio using the second radio interface. The first radio station can obtain from the path information in relation to each other radio station of the group, the neighboring radio station to which a message from the first radio station addressed to the relevant other radio station of the group is to be transmitted using the first radio interface.

The group of radio stations can for example be radio stations of a WLAN, including for example network-side radio stations in the form of radio access points and relay stations, and also stationary or mobile subscriber-side radio stations The further radio station, which is not part of the group of radio stations, can for example be realized as a base station of a cellular radio communications system. Two different radio interfaces are used, whereby radio interfaces can differ depending on the actual embodiment of the system considered especially through the use of different radio frequencies. In addition or as an alternative the use of different radio transmission standards, such as UMTS, GSM, IEEE 802.11, HiperLan for example, and/or different radio transmission methods, such as CDMA, TDMA, OFDM for example, are possible for different radio interfaces. It is advantageous for the first radio interface involved to be a WLAN radio interface and for the second radio interface involved to be an interface of a cellular radio communications system.

First, a radio station of the group determines one or more radio stations in its neighborhood. Neighboring radio stations are identified by the fact that they can communicate with each other by radio directly, that is without message forwarding via other radio stations, what is referred to as one-hop communication is possible between neighboring radio stations. In this case the number of neighboring radio stations depends on the transmit power used for the radio communication network. Thus for example a radio station with low transmit power can have no neighboring radio stations, with medium transmit power one neighboring radio station and with high transmit power two neighboring radio stations.

After the further radio station has received neighborhood information from the first radio station of the group, the sending of path information is carried out by the further radio station. This path information can especially be sent automatically, which means without a prior request from the first radio station of the group for the path information in general or for a specific path having been made. The path information relating to the first radio station involves a path to other radio stations of the group in each case, in which case it is possible for it to contain information about paths to all radio stations or also only to the non-neighboring radio stations of the first radio station. The path information must however not necessarily involve the complete path to other radio stations of the group; at least however the first radio station is notified of a radio station in its neighborhood which is a component of the relevant path. The first radio station thus knows about the relevant neighboring radio station for a transmission of a message addressed to any other radio station of the group, the message is to be sent from the first radio station using the first radio interface in which case this applies to any other radio station of the group. Thus in the case in which it intends to send a message to any radio station of the group, the first radio station does not need any further routing or path information for transmission, instead the message can be transmitted as a result of the knowledge of the path information transferred from the further radio station immediately to the neighboring radio station indexed with the path information. The neighboring radio stations which have received such a message from the first radio station can then forward this message provided they are not the addressed recipients of the message.

The method described can also be executed for a number of radio stations of the group by the radio stations executing operations i and ii and subsequently in operation iii receiving the relevant path information from the further radio station.

In a further development, the further radio station, after receiving the information about the at least one neighboring radio station determined by the first radio station, transfers to a plurality of radio stations or to all radio stations of the group the appropriate path information in each case using the second radio interface. This means that while operations i and ii are executed by the first radio station, operation iii is executed both in relation to the first, and also in relation to one or more other radio stations of the group. In this case the path information transferred to the various radio stations differs in its content. The path information sent to each radio station of the group is identified as described above in relation to the first radio station by the fact that a radio station which receives the path information intended for it can obtain from this path information in relation to every other radio station of the group or in relation to each radio station of the group not in its neighborhood, the neighboring radio station in each case to which the message of the radio station addressed to the relevant other radio station of the group from the radio station to which the path information is directed, is to be transmitted using the first radio interface. If the path information is not transmitted to all but merely to a majority of radio stations of the group, the determination of the majority can be subject to a condition, such as for example whether path information transmitted beforehand is significantly changed by the neighborhood relationships newly determined by the first radio station of the group.

In an embodiment, the path information, in addition to specifying neighboring radio stations, also includes a specification of the transmit power to be used for transmission of messages to a relevant neighboring radio station. The path information can then for example be structured according to the following scheme: Destination radio station: X, neighboring radio station on the path to destination radio station X: Y, transmit power to be used for transmitting a message to the radio station Y: Z.

It is especially advantageous for the first radio station concerned to be a radio station which has been newly added to the group of radio stations or has changed its geographical position within the group. A radio station has for example been newly added to the group of radio stations if it was not previously a member of the group, for example because it was too far away from the radio stations of the group to enable it to communicate with them by radio over the first radio interface, or if it was not available previously for communication with the other radio stations of the group using the first radio interface, for example because it was switched off. The method is advantageous in the case of a newly added radio station or a station which changes its geographical position especially if the further radio station or a device connected to the further radio station already knows about neighborhood information of the other radio stations of the group at the time at which it receives the neighborhood information from the first radio station. In this case the method makes possible flexible network planning within the group of radio stations, since at any time new radio stations can be included in the group of radio stations.

In a further development, the first radio station determines at least one radio station of the group in its neighborhood by using the first radio interface to emit a signal or a number of signals with different transmit power and receives reply signals from the radio station or radio stations of the group which have received such a signal. For example signals can be emitted by the first radio station with transmit power which increases from signal to signal. The emission of signals with different transmit power in combination with the receipt of the relevant reply signal results in the knowledge of the number of neighboring radio stations as a function of the transmit power used. As regards the reply signal it is possible for each radio station to reply to each received signal or for a reply to only be sent the first time that a signal is received.

It is advantageous if the information transferred from the first radio station to the further radio station about the at least one neighboring radio station includes in each case the specification of a transmit power usable for communication with the relevant neighboring radio station. A usable transmit power can for example represent at least one transmit power to be used or also a transmit power with which the first radio station has received a reply signal from the relevant neighboring radio station.

In an embodiment, the method is executed in relation not only to the first radio station but to all radio stations of the group. This means that all radio stations of the group execute operations i and ii and in operation iii receive the path information which is appropriate to them. This procedure is especially useful during commissioning, checking or start of communication within the group of radio stations. In this case the further radio station knows as a result of the neighborhood information transfer in operation ii the entire topology of the network of the group of radio stations, and can thus determine paths between all radio stations of the group.

In an advantageous embodiment, the further radio station requests the first radio station or the first radio station and one or more other radio stations of the group to determine neighboring radio stations of the group in each case and to transfer information about the relevant neighboring radio stations determined. Such a request can especially go out to all radio stations of the group. For example the request by the further radio station can be made as a result of receiving an error messages from at least one radio station of the group by the further radio station. Such an error message can for example be triggered by a message between radio stations of the group not being able to be transmitted over a path since one radio station of the path has failed.

In a further development the path information is transferred to the first radio station or to the first radio station and one or more other radio stations of the group as a result of receipt of a message from at least one radio station of the group by the further radio station Thus for example a radio station of the group can establish that it is too heavily loaded by the receipt and/or forwarding of messages and can notify this to the further radio station which subsequently recalculates paths and transmits the relevant new path information to the radio stations of the group.

A first radio station for communication in a radio communications system, which is made up of a group of radio stations including the first radio station and a number of other radio stations including a second radio station, determines identification information about radio stations of the group in its neighborhood using a first radio interface. The first radio station transmits information about neighboring radio stations determined by it to the second radio station using a second radio interface and receives path information sent by the second radio station using the second radio interface. The first radio station obtains from the path information in relation to each other radio station of the group, the neighboring radio station in each case to which a message addressed to the other radio station of the group is to be transmitted from the radio station using the first radio interface.

Another example is a radio station for communication in a radio communications system which includes a group of other radio stations, including a first further radio station and other radio stations. Information from radio stations in the group about the radio stations of the group in the neighborhood of is received by this radio station and used to determine paths between radio stations of the group. This radio station also determines unsolicited transmission of path information to the first further radio station of the group after the receipt of new information about radio stations of the group in the neighborhood of the first further radio station of the group, in which case it can be taken from the path information by the first further radio station of the group in relation to each other radio station of the group, possibly with the exception of the radio stations in its neighborhood, to which adjacent radio station of the first further radio station a message addressed to the other radio station of the group in each case is to be transmitted from the first further radio station using the first radio interface. New neighborhood information means in this case that this information is not yet known to the radio station, the novelty of the information can for example be caused by a change of position of a radio station within the group or by a new radio station entering the group.

The two such radio stations are especially suitable for executing the method described herein. Furthermore it is possible for the method to be implemented by a plurality of interconnected devices.

### BRIEF DESCRIPTION OF THE DRAWINGS

These and other objects and advantages will become more apparent and more readily appreciated from the following description of an exemplary embodiment, taken in conjunction with the accompanying drawings of which:

FIG. 1 is a block diagram of a portion of a radio communications system,

FIG. 2 is a flowchart of a method described below,

FIG. 3 is a block diagram of a WLAN radio station and a base station used in the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

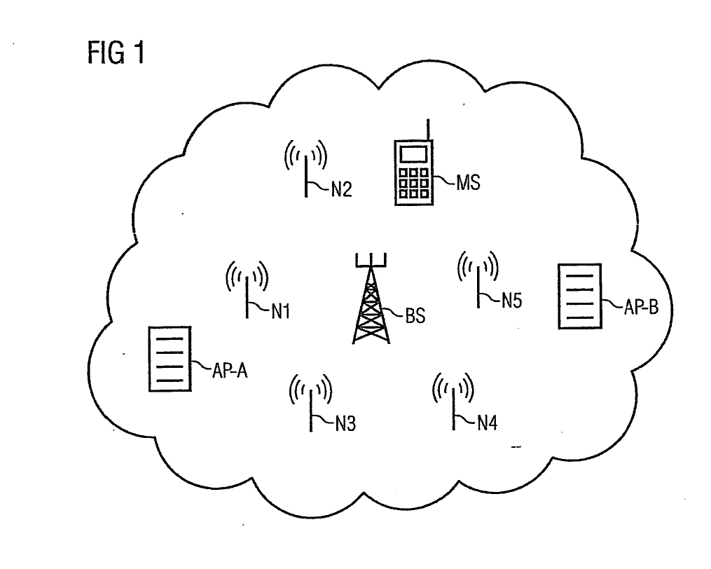

The radio cell of base station BS of a cellular radio communications system is shown in FIG. 1—indicated by a cloud symbol. The cellular radio communications system can for example be a system in accordance with GSM or UMTS standard. The following radio stations of a WLAN are located in the radio cell of the base station BS: Two radio access points AP-A and AP-B and the relay stations N1, N2, N3, N4 and N5. The subscriber-side mobile station MS which is located outside the radio coverage area of the radio access points AP-A and AP-B, can communicate with the radio access points AP-A and AP-B, in that messages are forwarded via the relay stations N1, N2, N3, N4 and N5. It is also possible for the mobile station MS to communicate with further subscriber-side radio stations which may be present—not shown in FIG. 1—via relay stations N1, N2, N3, N4 and N5. The explanations below are based on the assumption that relay stations N1, N2, N3, N4 and N5 involved are stationary network-side radio stations. The method is however also applicable to cases in which the relay stations N1, N2, N3, N4 and N5 or at least some of the relay stations N1, N2, N3, N4 and N5 are stationary or mobile subscriber-side radio stations.

Base station BS communicates with the relay stations N1, N2, N3, N4 and N5, the radio access points AP-A and AP-B and if necessary also with the mobile station MS using the radio interface of the cellular radio communications system. The relay stations N1, N2, N3, N4 and N5, the radio access points AP-A and AP-B, and the mobile station MS communicate using the radio interface of the WLAN. Since a higher frequency is used for the radio interface of the WLAN than for the cellular radio interface, the radio coverage area for a communication using the WLAN radio interface is far smaller than for communication with the base station BS of the cellular system.

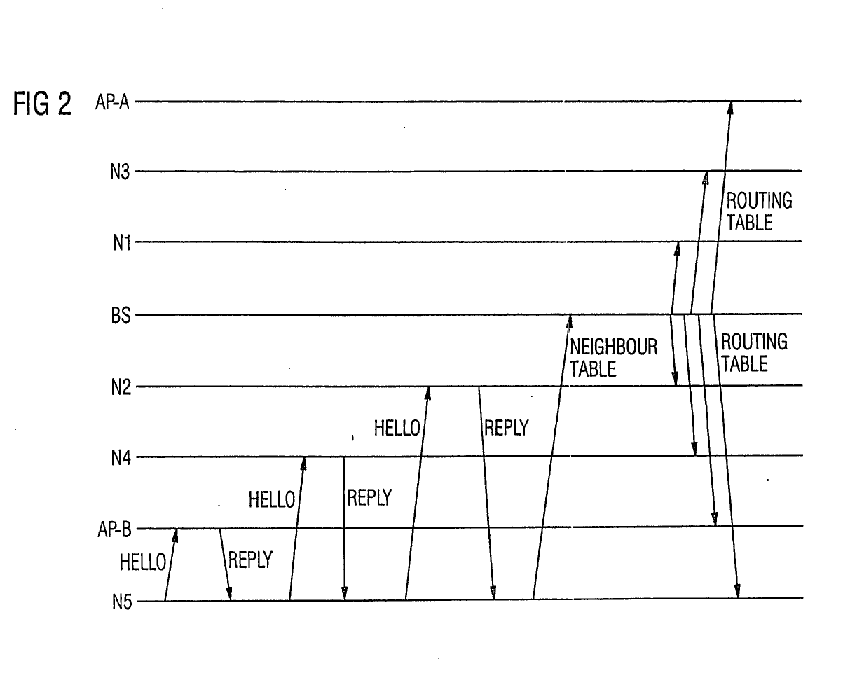

The case is considered below in which the relay station N5 enters the network of radio stations of the WLAN as a new station. The execution sequence of the method in relation to the integration of relay station N5 is shown in FIG. 2. To determining, which radio stations are in the neighborhood of the new relay station N5, the relay station N5 transmits a series of HELLO signals using the WLAN radio interface. Two radio stations are neighbors if they can communicate directly with each other, without messages between them having to be forwarded by other radio stations. In general the number of radio stations which are in the neighborhood of a specific radio station depends on the transmit power used for communication between the radio stations. Initially the relay station N5 sends a HELLO signal at low transmit power. Only the radio access point AP-B receives the first HELLO signal an replies to It with the REPLY signal, from which the relay station N5 can recognize that the radio access point AP-B represents a neighboring radio station in relation to the transmit power used for the first HELLO signal.

Subsequently a second HELLO signal is emitted by the relay station N5 at higher transmit power which is received by the relay station N4 and is replied to with the REPLY signal. Finally the relay station N2 replies to the third HELLO signal emitted with further increased transmit power. The REPLY replies each include information about the sender of the reply. In this way the relay station N5 can determine its neighboring radio stations, depending on the transmit power used in each case.

After determination of the neighboring radio stations is completed, which can for example be conditional on the use of a specific maximum transmit power or the determination of a specific minimum number of neighboring radio stations, the relay station N5 sends identification information about its neighbors that it has identified AP-B, N4 and N2, with reference to the transmit power used in each case, to the base station BS. To transmit this message NEIGHBOUR TABLE the relay station N5 uses the radio interface of the cellular radio communications system.

The base station BS already knows about such neighboring relationships in relation to the other radio stations, i.e. for the relay stations N1, N2, N3 and N4, as well as for the radio access points AP-A and AP-B, since this has already previously executed a method described above for determining its neighboring radio stations depending on the transmit power used and has sent the results to the base station BS. After the relay station N5 has been inserted into the WLAN and information about radio stations in its neighborhood has been sent to the base station BS, the entire topology of the networks of the WLAN radio stations is known to the base station BS.

The base station BS determines on receipt of the message NEIGHBOUR TABLE of the relay station N5 paths for all combinations of transmitting and receiving radio stations of the WLAN. In relation to the relay station N5 for example a path to the two radio access points AP-A and AP-B and to the relay stations N1, N2, N3 and N4 is determined. The base station determines these paths using the neighborhood relationships already transferred to it by the new relay station N5 and by the other radio stations.

Following on from the path determination the base station BS transmits to each radio station of the WLAN a ROUTING TABLE message, the content of which differs from radio station to radio station. The ROUTING TABLE message contains the first radio station of a path to every other radio station in each case. Thus the ROUTING TABLE message contains pairs of radio stations, whereby for each pair the first radio station of the pair represents a destination radio station and the second radio station of the pair represents the neighboring radio station which lies on the path to this destination radio station determined by the base station BS. In relation to the relay station N5 for example the ROUTING TABLE message can contain the following entries: Destination radio station AP-B, next radio station on the path: AP-B; Destination radio station N4, next radio station on the path: N4; Destination radio station N3, next radio station on the path: N4; Destination radio station N2, next radio station on the path: N2; Destination radio station N1, next radio station on the path: N2; Destination radio station AP-A, next radio station on the path: N2. It is also possible to name a number of neighboring radio stations on the path to a destination radio station, thus for example Destination radio station AP-B, next radio station on the path: N4 or N2. It is further possible for paths to neighboring radio stations of the relay station N5 not to be contained in the ROUTING TABLE message of the relay station N5, since the relay station N5 has determined this as neighboring and thus knows the path. In this case the ROUTING TABLE message of the relay station N5 can contain the following entries: Destination radio station N3, next radio station on the path: N4; Destination radio station N1, next radio station on the path: N2; destination radio station AP-A, next radio station on the path: N2.

Because of the ROUTING TABLE message the relay station N5 thus knows for each destination radio station of a message about the neighboring radio station to which the relevant message is to be sent. A route determination or a request for a route at the base station BS is thus not necessary in an on-demand case, i.e. before the transmission of a message to any given radio station of the WLAN.

A correspondingly structured ROUTING TABLE message is also sent to the other radio stations of the WLAN from the base station BS. Thus each radio station of the WLAN knows about a suitable neighboring radio station for sending a message every other radio station of the WLAN.

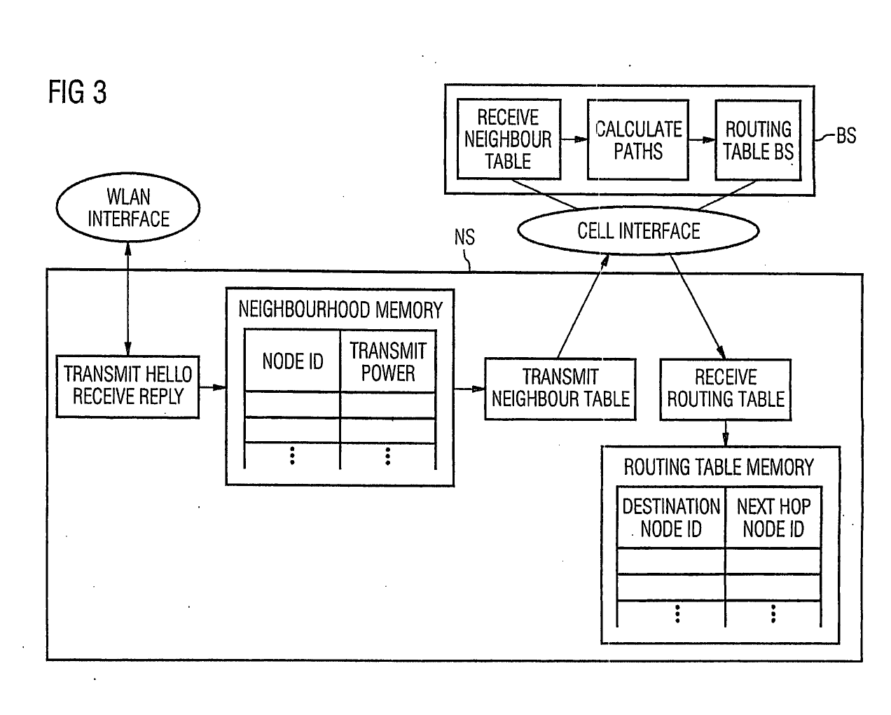

FIG. 3 shows schematically the structure of the relay station N5 and of the base station BS. The relay station N5 can communicate both via the WLAN radio interface WLAN INTERFACE and also via the cellular radio interface CELL INTERFACE, whereas the base station BS only communicates via the cellular radio interface CELL INTERFACE. Neighboring radio stations are determined by the relay station N5 using TRANSMIT HELLO RECEIVE REPLY. The neighborhood information determined is held in a memory NEIGHBOURHOOD MEMORY, e.g. in the tabular form shown, with a first column containing identification information NODE ID of the neighboring radio stations and a second column containing the transmit power TRANSMIT POWER used to transmit the HELLO message replied to in each case by the neighboring radio station. The TRANSMIT NEIGHBOUR TABLE is used to create the message NEIGHBOUR TABLE and to transmit it over the cellular radio interface CELL INTERFACE. The path information of the ROUTING TABLE message is received for the RECEIVE ROUTING TABLE via the cellular radio interface CELL INTERFACE and stored in the memory ROUTING TABLE MEMORY. The path information can for example be stored as shown in tabular form, with a first column specifying a destination radio station DESTINATION NODE ID for a message and a second column the neighboring radio station NEXT HOP NODE ID, to which the message addressed to the associated destination radio station DESTINATION NODE ID is to be transmitted.

The base station BS has the RECEIVE NEIGHBOUR TABLE available for receiving and storing NEIGHBOUR TABLE messages received from the radio stations of the WLAN via the cellular radio interface CELL INTERFACE. The paths between different radio stations of the WLAN are determined using the neighborhood information of the messages NEIGHBOUR TABLE with the CALCULATE PATHS. The creation and transmission of the ROUTING TABLE messages via the cellular radio interface CELL INTERFACE is undertaken using the ROUTING TABLE BS. In this case the path determination as well as the creation and transmission of the ROUTING TABLE messages is initiated by the arrival of the new neighborhood information in the RECEIVE NEIGHBOUR TABLE.

The ROUTING TABLE messages of the base station BS can, in addition to the pairs of destination station and associated neighboring radio station, also include the transmit power to be used. In this case the table of the ROUTING TABLE MEMORY contains a triplet of variables in each line. Thus the relevant radio station, when transmitting messages, does not have to refer back to value of the transmit power TRANSMIT POWER stored in the memory NEIGHBOURHOOD MEMORY.

For the base station BS the knowledge of the transmit power belonging to each neighboring radio station is relevant for determination of paths. Thus the use of neighboring radio stations far away for a path results in a path with few radio stations and thereby a rapid message transmission via the path. However the radio stations must use a high transmit power for message transmission over great distances between neighboring radio stations, which can lead to problems with interference occurrences for other message transmissions. These mutual effects are taken into account by the base station BS when determining the paths in order to make the operation of the WLAN as efficient as possible in this way.

FIG. 2 looks at the case in which, as an initial situation, all neighborhood relationships between the radio stations AP-A, AB-B, N1, N2, N3 and N4 are known to the base station BS, and then a new relay station N5 is added. Triggered by the receipt of the information about neighboring radio stations of the new relay station N5, the base station BS determines the path between the radio stations AP-A, AB-B, N1, N2, N3, N4 and N5 of the WLAN again and transmits the relevant path information in each case about neighboring radio stations to be used to the radio stations AP-A, AB-B, N1, N2, N3, N4 and N5. Another situation, in which the determination of neighboring radio stations is of interest occurs if a radio station of the WLAN is no longer available as it was previously for message transmission or forwarding. The reason for this can be for example that a relay station N1, N2, N3, N4 or N5 is prevented as a result of technical problems, or because, in the case of non-stationary relay stations N1, N2, N3, N4 and N5 a relay station changes its location. If a radio station of the WLAN fails for these reasons, another radio station of the WLAN, which has detected the failure when attempting—to send a message over the path involved, sends an error messages to the base station BS. The base station BS then requests the radio stations AP-A, AB-B, N1, N2, N3, N4 and N5 of the WLAN to determine neighboring radio stations once more. After information about the relevant neighboring radio stations determined has been sent to the base station BS, the base station BS can determine a new path between the radio stations AP-A, AB-B, N1, N2, N3, N4 and N5 and transmit the corresponding path information to the radio stations AP-A, AB-B, N1, N2, N3, N4 and N5 of the WLAN.

A further option for re-determining the path is provided in the case in which one of the radio stations AP-A, AB-B, N1, N2, N3, N4 and N5, especially one of the two radio access points AP-A or AP-B, determines that its own traffic load is too great i.e. the resources available for radio communication are not sufficient to transmit the necessary messages. In this case the radio station involved can send a message to the base station BS, in which case the message contains for example all radio stations from which it receives data and to which it has to transmit data, including the relevant scope of the data, whereupon the base station BS re-determines some paths in order in this way to reduce the load on the radio station involved. This can be implemented for example by the radio station concerned only still sending or receiving messages with reduced transmit power, so that the number of neighboring radio stations present overall which is dependent on the transmit power used is reduced.

The procedure described makes it possible to adapt the size of the WLAN flexibly in that new radio stations can enter the WLAN at any time or also be removed from it. In such cases no planning is required for the locations at which radio stations can be inserted or removed, without adversely affecting the balance of the network of radio stations, since such a change to the number of radio stations is accompanied by a determination of the neighboring radio stations of the new radio station or all radio stations and a re-determination of the path. Furthermore the proposed solution supports the mobility of relay stations or also of radio access points of a WLAN.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for communication in a radio communications system having a group of radio stations and a further radio station, the group including a first radio station and a plurality of other radio stations, said method comprising:
determining by the first radio station, at least one neighboring radio station of the group with respect to a first radio interface;
transmitting neighborhood information about the at least one neighboring radio station from the first radio station to the further radio station using a second radio interface;
determining, by the further radio station, path information using the neighborhood information transmitted by the first radio station and additional neighborhood information transferred from the other radio stations of the group relating to neighborhood relationships between the radio stations of the group, the path information defining how a message can be sent from the first radio station to any of the other radio station of the group using the first radio interface; and
transmitting the path information from the further radio station to at least the first radio station using the second radio interface.

13. A method as claimed in claim 12,
wherein said determining and transmitting of the neighborhood information by the first radio station is performed for several neighboring radio stations of the group, and
wherein said determining and transmitting of the path information using the second radio interface by the further radio station are performed after receiving the neighborhood information for the first radio station and the several radio stations of the group.

14. A method as claimed in claim 13, wherein the path information, in addition to information about neighboring radio stations, contains information about a transmit power to be used for transmission of messages to the neighboring radio stations, respectively.

15. A method as claimed in claim 14, wherein the first radio station is newly added to the group of radio stations or has changed geographical position within the group prior to said determining of the at least one neighboring radio station.

16. A method as claimed in claim 15, wherein said determining of the at least one neighboring radio station by the first radio station includes
emitting at least one of a signal and a plurality of signals with different transmit powers using the first radio interface; and
receiving at least one reply signal, using the first radio interface, from the at least one neighboring radio station of the group which received the at least one of the signal and the plurality of signals.

17. A method as claimed in claim 16, wherein the neighborhood information transmitted by the first radio station to the further radio station about the at least one neighboring radio station includes a specification about the transmit power which can be used for communication with each of the at least one neighboring radio station.

18. A method as claimed in claim 17, further comprising repeating said determining and transmitting of the neighborhood information and the path information for all of the radio stations of the group.

19. A method as claimed in claim 18, further comprising requesting, by the further radio station, at least the first radio station to determine the at least one neighboring radio station of the group and to transmit the neighborhood information.

20. A method as claimed in claim 19,
further comprising receiving an error message from at least one radio station of the group by the further radio station, and
wherein said requesting is in response to said receiving of the error message by the further radio station.

21. A method as claimed in claim 20,
further comprising receiving a message from at least one radio station of the group by the further radio station, and
wherein said transmitting of the path information to at least the first radio station of the group is in response to said receiving of the message by the further radio station.

22. A radio station for communication in a radio communication system having a group of other radio stations, comprising:
means for receiving via a first radio interface, neighborhood information from the other radio stations about neighboring radio stations of the group neighboring each of the other radio stations;
means for storing the neighborhood information;
means for determining, using the neighborhood information, path information about paths between the other radio stations using a second radio interface; and
means for unsolicited transmitting, via the first radio interface, of the path information required for one of the other radio stations to send a message to any of the other radio stations of the group using the second radio interface, in response to receipt of new information about at least one neighboring radio station neighboring the one of the other radio stations.
